(19) United States
(12) Patent Application Publication
(10) Pub. No.: US 2024/0152574 A1
(43) Pub. Date: May 9, 2024

(54) WEIGHT EXPANSION TO REDUCE WEIGHT PRECISION

(71) Applicant: INTERNATIONAL BUSINESS MACHINES CORPORATION, ARMONK, NY (US)

(72) Inventors: Stefano Ambrogio, San Jose, CA (US); Andrea Fasoli, San Jose, CA (US)

(21) Appl. No.: 18/052,903

(22) Filed: Nov. 4, 2022

(51) Int. Cl. G06F 17/16; G06N 3/0442

(52) U.S. Cl. CPC G06F 17/16; G06N 3/0442

(57) ABSTRACT

A computer-implemented method to generate weights and inputs in a multiply-and-accumulate (MAC) operation that are resilient to reduced precision. The method includes providing a matrix M and its pseudoinverse M⁻¹. Weights W are multiplied with M⁻¹ and an input vector value x is multiplied with M. Two new matrices W₂ and x₂ are defined based on the multiplying of W with M⁻¹ and x with M. The matrices W₂ and x₂ are encoded with increased resilience to reduce precision in place of the weights W and input vector value x.

### BACKGROUND

### Technical Field

The present disclosure generally relates to weight precision of weights and inputs in a Multiply-And-Accumulate operation of a structured weight (Swx) matrix, and more particularly, to reducing weight and inputs sensitivity in computing operations.

### Description of the Related Art

Analog in-memory (Analog AI) applications are being developed to overcome bottleneck issues and enhance parallel computing operations. In one non-limiting example, the use of crossbar arrays constructed of non-volatile memory elements may eliminate the passing of data between a CPU and memory. The result is a dramatic increase in computing speed. However, noise sensitivity of weights and inputs impact the accuracy of the parallel computing operations performed.

### SUMMARY

According to one embodiment, a computer-implemented method to generate weights and inputs in a multiply-and-accumulate (MAC) operation that are resilient to reduced precision. The method includes providing a matrix M and its pseudoinverse M⁻¹. Weights W are multiplied with M⁻¹ and an input vector value x is multiplied with M. Two new matrices W₂ and x₂ are defined based on the multiplying of W with M⁻¹ and x with M. The matrices W₂ and x₂ are encoded with increased resilience to reduce precision in place of the weights W and input vector value x. The new matrices have increased size possibly and increase the quantity of weights when reducing the precision of the weights.

In one embodiment, which may be combined with the previous embodiment, the pseudoinverse M⁻¹ is provided by performing a Moore Penrose inversion pinv. As the matrices are not squares, pseudo-inversion rather than inversion is performed. Moore Penrose is an efficient way to perform the pseudo-inversion operations.

In one embodiment, which may be combined with the previous embodiments, a quantity of weights in W₂ is greater than in W. When the precision of the weights is reduced, there may be an increase in the total number of weights used. Such an increase in weights may have a negligible impact on hardware from an Analog-AI viewpoint, but from a digital viewpoint, the increased quantity of weights can be compensated with a reduction in precision with overall less of a computational load.

In one embodiment, which may be combined with the previous embodiments, a precision of each weight in W₂ is reduced by performing a quantizing operation, whereas the weights are encoded with a decreased number of bits. Quantizing provides a measurable way of reducing the precision of the weights.

In one embodiment, which may be combined with the previous embodiments, the matrix M provided is a random matrix. The use of a random matrix is a more efficient way to expand the weights and inputs and generate new matrices that are more resilient to reduced precision.

In one embodiment, which may be combined with the previous embodiments, the provided random matrix is extracted from a distribution selected from the group consisting of Gaussian, uniform, Cauchy and triangular. The distributions may be used to provide matrices that are more resilient to reduced precision.

In one embodiment, which may be combined with the previous embodiments, the precision of each weight in W₂ is reduced by encoding W₂ in Analog hardware. Writing weights in Analog hardware introduces noise into W or W₂ (e.g., the written weights do not correspond exactly to what is desired to write), thereby reducing the weights precision. W₂ is more resilient to noise than W.

In one embodiment, which may be combined with the previous embodiments, the precision of each weight in W₂ is reduced by encoding W₂ and M in Analog hardware. Similar to the explanation in the above paragraph, writing weights in Analog hardware introduces noise into W or W₂, and W₂ is more resilient to noise than W.

According to one embodiment, a computing device is configured to reduce a precision of weights and inputs in a multiply-and-accumulate (MAC) operation. The computing device includes a processor, a memory coupled to the processor, the memory storing instructions to cause the processor to perform acts including providing a matrix M and its pseudoinverse M⁻¹. One or more weights W may be multiplied with M⁻¹ and an input vector value x is multiplied with M. Two new matrices W₂ and x₂ are defined based on the multiplying of W with M⁻¹ and x with M. The matrices W₂ and x₂ are encoded with a reduced precision in place of the one or more weights W and input vector value x. The new matrices have increased size to allow for a higher resilience to weight noise or reduced precision.

In one embodiment, which may be combined with the previous embodiment, the instructions cause the processor to perform an additional act of providing the pseudoinverse M⁻¹ by performing a Moore Penrose inversion pinv. Moore Penrose enables inversion of non-square matrices.

In one embodiment, which may be combined with the previous embodiments, the computing device has a quantity of weights in W₂ that are greater than in W. Reducing the precision of the weights can decrease the computational load, and there may be an increase in overall weights with less precision.

In one embodiment, which may be combined with the previous embodiments, the instructions cause the processor to perform an additional act of reducing the precision of each weight in W₂ by performing a quantizing operation. The computational load is decreased by performing the quantizing operation.

In one embodiment, which may be combined with the previous embodiments, the instructions cause the processor to perform an additional act of reducing the precision of one or more weights by decreasing a number of bits per weight. The reduced precision will decrease the computational load.

In one embodiment, which may be combined with the previous embodiments, the instructions cause the processor to perform an additional act of providing a random matrix. The random matrix is used to expand the weight layers of a memory.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 is an illustration of a Long Short Term Memory (LSTM) layer expansion, consistent with an illustrative embodiment.

FIG. 2 shows graphs of a Word Error Rate (WER) versus a bit Weight (W) quantization of an encoded Long Short Term Memory (LSTM) and of a full network, consistent with an illustrative embodiment.

FIG. 3 illustrates an example of expanding weights Wₓ using a random matrix M and its pseudo-inverse M⁻¹, consistent with an illustrative embodiment.

FIG. 4 shows a quantization applied to an expanded matrix Wₓ₂ and the comparison with the quantization W_{xQ} of the original Wₓ matrix, consistent with an illustrative embodiment.

FIG. 5 is graph showing a distribution of the errors |δWₓ₂M| vs. |δWₓ|, consistent with an illustrative embodiment.

FIG. 6 is a flowchart illustrating an operation of weight reduction, consistent with an illustrative embodiment.

FIG. 7 is a functional block diagram illustration of a particularly configured computer hardware platform, consistent with an illustrative embodiment.

FIG. 8 depicts an illustrative cloud computing environment, consistent with an illustrative embodiment.

FIG. 9 depicts a set of functional abstraction layers provided by a cloud computing environment, consistent with an illustrative embodiment.

### DETAILED DESCRIPTION

### Overview

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high level, without detail, to avoid unnecessarily obscuring aspects of the present teachings. It is to be understood that the present disclosure is not limited to the depictions in the drawings, as there may be fewer elements or more elements than shown and described.

As used herein, the term “quantization” refers to a reduction in the number of digits representing a particular entity. For example, an item with a weight expressed in multiple digits (e.g., 8 digits) after quantization may be expressed in fewer digits (e.g., 3 digits).

As used herein, the phrase “increased resilience to reduced precision” is to be understood to means to maintain the precision or limit the variation in the output of the MAC operation, as compared to the output obtained in the absence of reduced precision.

As used herein, the term “reduced precision” is to be understood to be values that are less accurate than the ideal case. For digital hardware, this term means using weights with fewer bits (quantized). For analog hardware, this term means introducing one or more noise sources into the weights.

In Analog-AI, there are parallel vector-multiply operations performed. Excitation vectors are introduced onto multiple row-lines to perform multiply and accumulate operations across an entire matrix of stored weights encoded into the conductance values of analog non-volatile resistive memories. Analog-AI uses matrix-vector multiplication to weight and sum multiplication noise. However, there may be different degrees of sensitivity among AI networks. While Hardware-Aware techniques have been developed to reduce network sensitivity, such techniques involve retraining of the network, which is lengthy and expensive.

In at least one embodiment of the present disclosure, network sensitivity to reduced precision is reduced through a manipulation of an existing model, without retraining the network. The computer-implemented method as disclosed herein shows better behavior if matrices M with larger sizes are used. From an Analog-AI viewpoint, such layer expansion can be a negligible issue because analog-AI can account for larger layers. From a digital viewpoint, reducing the precision can compensate for the increase in the number of the weights. Even using more weights, the encoding of each weight with a reduced precision can decrease the computational load on the hardware and at the same time provide for increased computational accuracy.

Maintaining the same MAC precision provides for a more accurate operation. Reducing the precision of the weights and inputs can be achieved digitally by a quantizing operation which replaces high precision values with low precision values. This quantizing can decrease the computational load of running a MAC operation.

Alternatively, weights can be subject to reduced precision due to the encoding process onto Analog hardware. Encoding weights on Analog hardware can introduce various sources of noise, which deviates the encoded weight from the target weights, thereby lowering their precision.

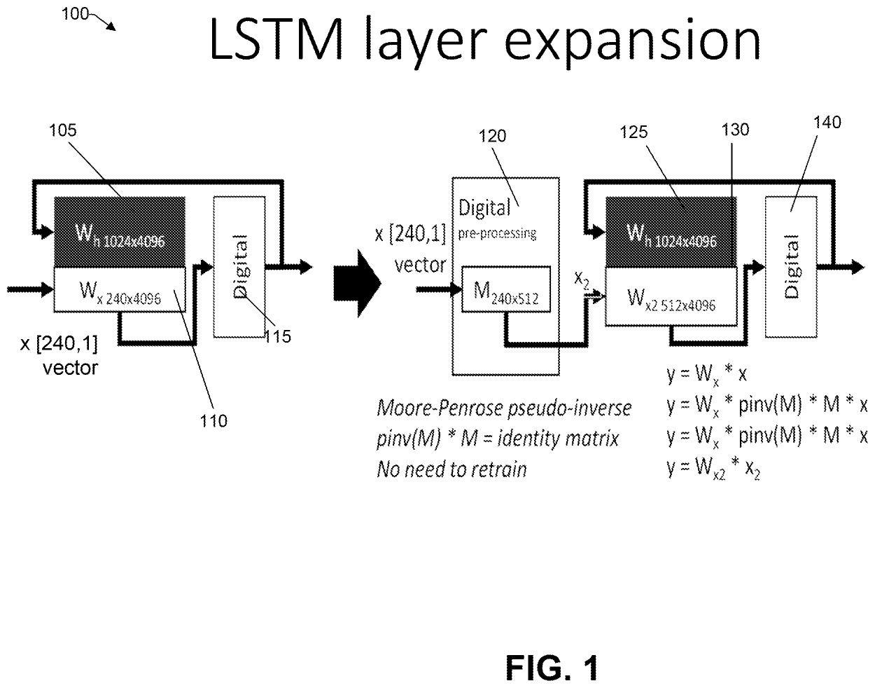

FIG. 1 is an illustration 100 of a Long Memory (LSTM) layer expansion used for vector multiplication, consistent with an illustrative embodiment. In this particular illustration, the provision of a LSTM layer expansion may occur in a Recurrent Neural Network Transducer (RNN-T). However, the present disclosure is not limited to any particular type of network, and may be broadly applied. There is shown a first matrix 105, which in this non-limiting illustration is configured at 1024×4096. The first matrix is part of a feedback loop with digital preprocessor 115. The second matrix 110 is arranged in a 240×4096 layout. A vector X is input to a digital pre-processor 120. A pseudo-inverse operation is performed using a matrix M, which generates a matrix M⁻¹=pinv(M). Through a multiplication (dot product) of the second matrix 110 with pinv(M), the second matrix 110 is expanded in size to 512×4096. Thus, there is shown a matrix Wₕ 125 that is 1024×4096 and the expanded matrix Wₓ 130, that is 512×4096 due to the multiplication (dot product) with pinv(M). In other words, in this example the original matrix of 240×4096 is expanded to 512×4096, which is more than a doubling of the matrix. The expanded size of the matrix 130 is used to increase a quantity of weights at a reduced level of precision. A digital processor 140 is included to perform any required digital operation. From a digital standpoint, the ability to reduce the precision may compensate for the increase in the number of weights. In other words, more weights are used in this process, but each weight can be encoded with a reduced precision without retraining the network. The reduction in precision advantageously reduces the computational load, and the increase in the quantity of weights offsets the reduction in precision. The expanded matrix Wₓ₂ also enables better resilience to weight noise in case analog devices are used to implement weights.

It is noted that as the matrix is not a square, the pseudo-inverse is performed. For example, a Moore-Penrose inversion (pinv*M) may be used. FIG. 1 shows how the multiplying of Wₓ with pinv(M) and x with M, two new matrices Wₓ₂ and x₂ are defined, and there is a better resilience to noise. By quantizing both Wₓ₂ and x₂, much better resilience to noise is achieved than from the original Wₓ matrix.

The computer-implemented method and computer device of the present disclosure advantageously provides improved performance. There is an improvement in the field of Analog-AI, as well as an improvement in computer operation. Resources that would be spent retraining a network due to the expanded matrix provides a savings in power and the computational load with the better resilience to noise.

Additional advantages of the computer-implemented method and device of the present disclosure are disclosed herein.

### Example of Bit Quantization Using an LSTM

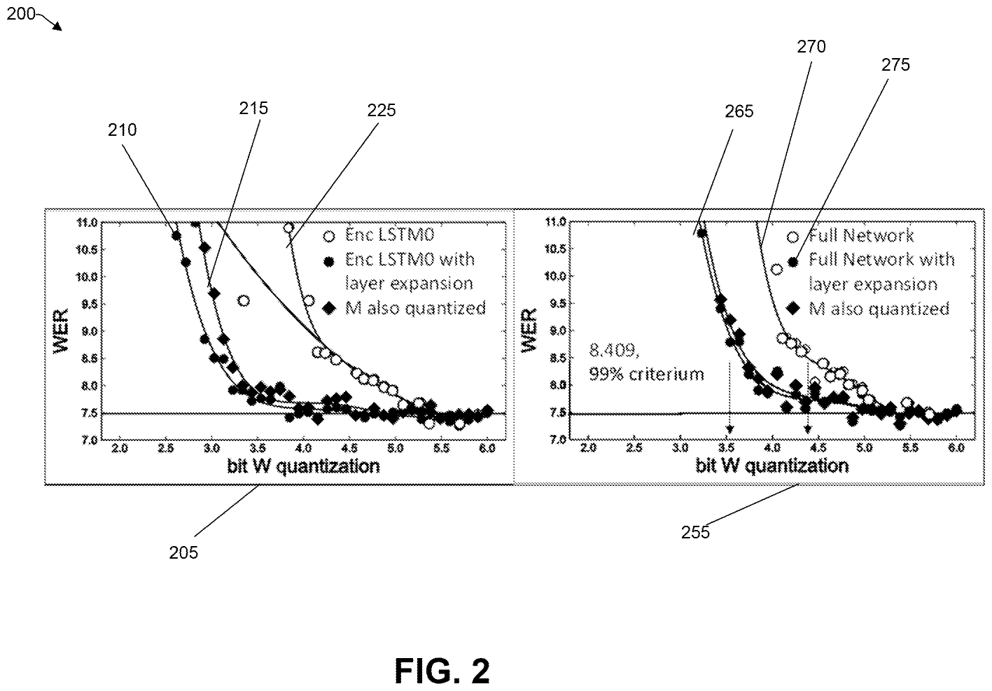

FIG. 2 shows graphs 200 of a Word Error Rate (WER) versus a bit Weight (W) quantization of an encoded Long Short-Term Memory (LSTM) and of a full network, consistent with an illustrative embodiment. In a non-limiting example where the arrangement of an LSTM in FIG. 1 is used in a speech-to-text application, FIG. 2 shows the effect of the bit W quantization on the WER with an encoded LSTM (graph 205) versus a full network in graph 255.

The graph 205 shows encodings 225 of an LSTM, encodings 215 with layer expansion, and 210 including a quantized matrix M. The graph 255 shows a full network 270, a full network with layer expansion 275, and the full network with M also quantized 265. In both graphs 205 and 255 a WER of 7.5 or less is desirable. As the bit W quantization is reduced, precision decreases and the WER increases, eventually leading to large degradation for very small number of bits.

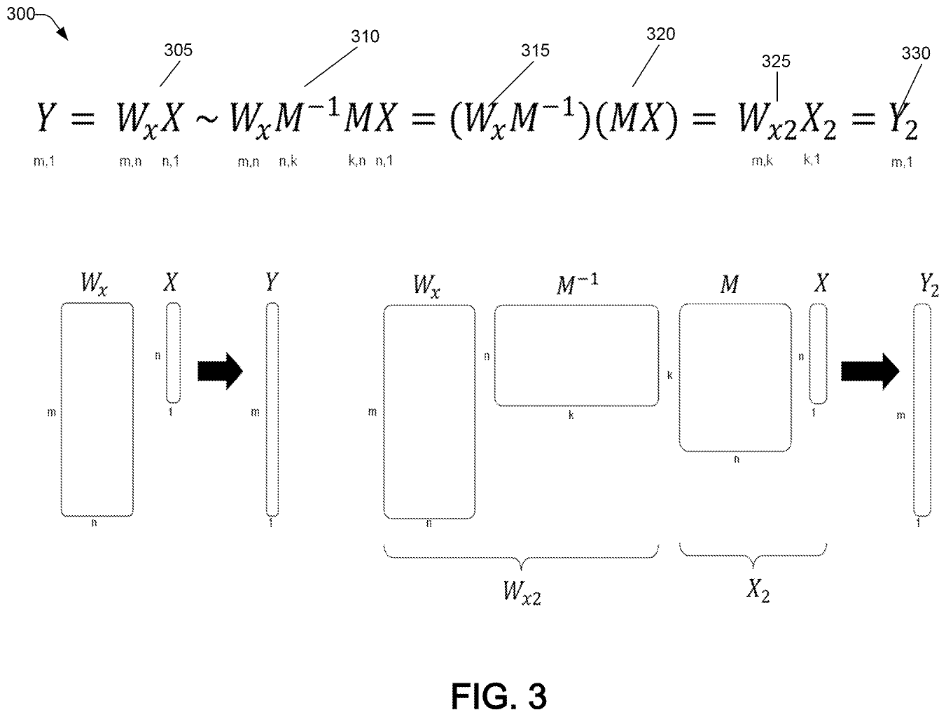

FIG. 3 illustrates the process flow 300 of expanding weights Wₓ using a random matrix M and its pseudo-inverse M⁻¹ operation, consistent with an illustrative embodiment. For example, the original operation 305 (Y=WxX) is shown. The pseudo-inversion 310 is shown in which there is a use of a Moore Penrose inversion (Pinv) in which the weight (Wₓ) and the vector X are multiplied with the introduced matrix M, which is restated in parentheses (WxM⁻¹ 315) and (Mx 320). The two new matrices Wₓ₂X₂ 325 are defined, with a resulting Y₂ 330. Below the equation shown in FIG. 3 is a matrix form of the equation (e.g., the matrices and vectors used in the vector multiplication to result in Y and Y₂), with m and n being the columns and rows of the matrices.

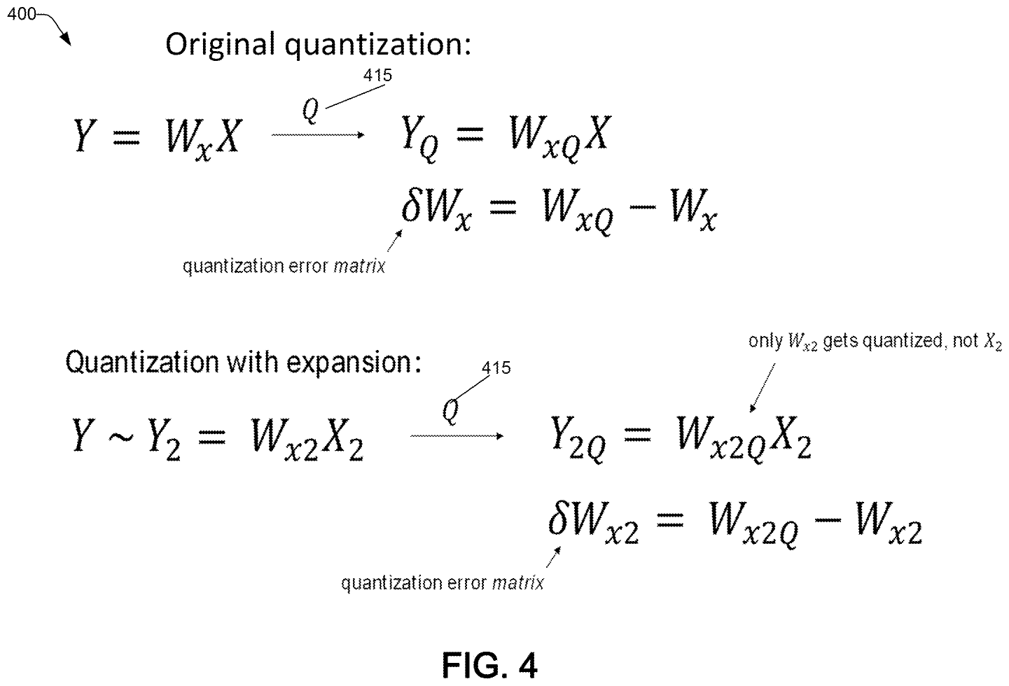

FIG. 4 shows a quantization 400 applied to an expanded matrix Wₓ₂ and the comparison with the quantization W_{xQ} of the original Wₓ matrix, consistent with an illustrative embodiment. The quantization of the original Wx matrix leads to YQ, and the weight error is:

δWₓ=W_{xQ}−Wₓ

Similarly, the expanded Wx2 matrix can be quantized, leading to Y2Q product. The corresponding weight error is:

δWₓ₂=W_{x2Q}−Wₓ₂

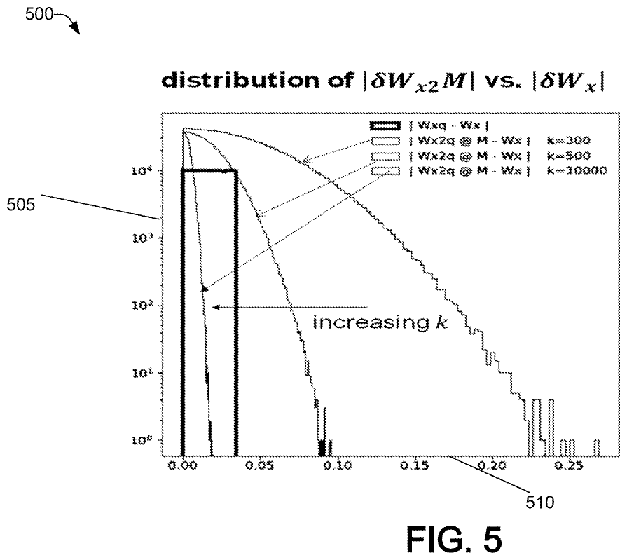

FIG. 5 is graph 500 showing a distribution of |δWₓ₂M| vs. |δWₓ|, consistent with an illustrative embodiment. FIG. 5 shows that as the k (size of the matrix) is increased, W_{x2Q}M matrix becomes a better approximation of Wₓ. Referring to FIG. 5, the dark black box on left and identified in the key is the original quantization error width when quantizing Wx to Wxq, and y axis 505 shows the quantization error distribution for values of k from 10⁰ to 10⁴. The x axis shows the error rate 510. As the value of K increases, it is shown that the error rate of the method shown and described herein approaches and becomes smaller than the original error rate. Thus, the expanded matrix can have less precise weights but still approach the accuracy of the original matrix through expansion of the matrix.

### Example Process

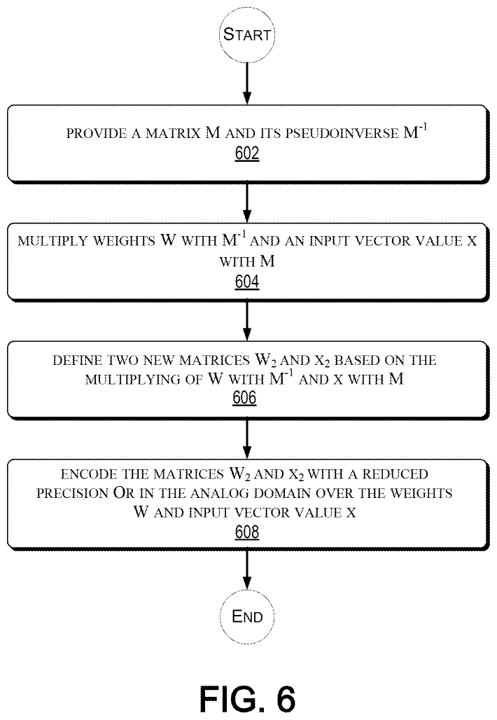

With the foregoing overview of the example architecture, it may be helpful now to consider a high-level discussion of an example process. To that end, FIG. 6 is a flowchart illustrating a method to reduce a precision of weights and inputs in a multiply-and-accumulate (MAC) operation consistent with an illustrative embodiment.

FIG. 6 is shown as a collection of blocks, in a logical order, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At operation 602, a random a matrix M is provided and its pseudoinverse M⁻¹. Referring to FIG. 1, the matrix 110 is 240×4096, and as it is not a square, a pseudo inversion using, for example, a Moore-Penrose pseudoinversion operation is performed. The use of the random matrix provides for the expansion of the weight layers into larger layers with reduced precision, which is beneficial for analog-AI hardware.

At operation 604, weights are multiplied with M⁻¹ and an input vector value with M. M⁻¹ is pseudoinversion operation that may be performed using a Moore Penrose inversion. However, the present disclosure is not limited to the use of the Moore Penrose inversion, and other pseudoinversion techniques may be used.

At operation 606, two new matrices are defined based on the multiplication in operation 604. The two new matrices W₂ and x₂ are defined by multiplying W with pinv (M) and x with M.

At operation 608, the matrices are encoded with a reduced precision as compared with the weights and input vector value X. The matrices are larger than the original matrix. For example, the matrix 110 shown in FIG. 1, which is 240×4096, is increased to 512×4096. More than double the size. The weights have reduced precision that may be implemented with a reduced number of bits, lowering the memory usage, or be more resilient to analog noise.

The computer-implemented method may end after operation 608. It is to be understood that there may be multiple iterations to increase the size of the matrices having more weights with reduced precision. These operations may be performed until there are matrices defined that are with compatible and/or operable with the hardware.

### Example Particularly Configured Computer Hardware Platform

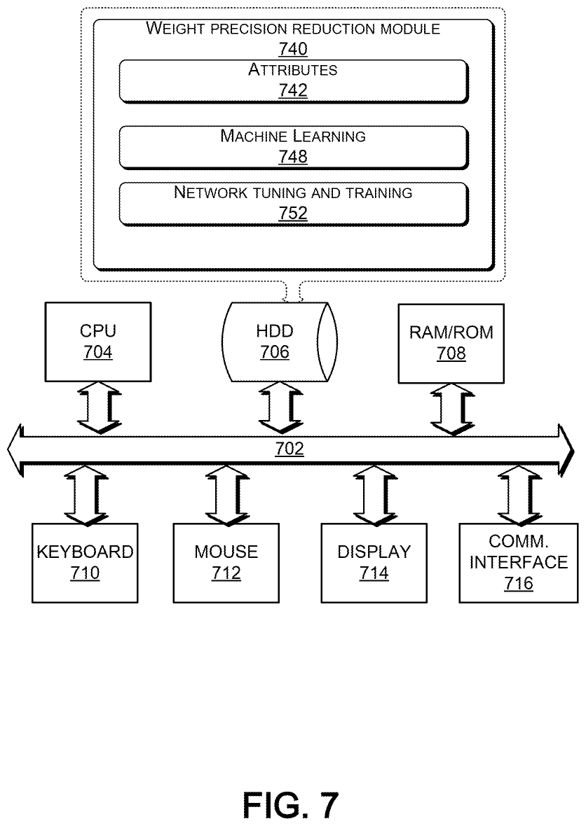

FIG. 7 provides a functional block diagram illustration 700 of a computer hardware platform. In particular, FIG. 7 illustrates a particularly configured network or host computer platform 700, as may be used to implement the method shown in FIG. 6.

The computer platform 700 may include a central processing unit (CPU) 704, a hard disk drive (HDD) 706, random access memory (RAM) and/or read-only memory (ROM) 708, a keyboard 710, a mouse 712, a display 714, and a communication interface 716, which are connected to a system bus 702. The HDD 706 can include data stores.

In one embodiment, the HDD 706 has capabilities that include storing a program that can execute various processes, such as machine learning and prediction optimization.

In FIG. 7, there are various modules shown as discrete components for ease of explanation. However, it is to be understood that the functionality of such modules and the quantity of the modules may be fewer or greater than shown.

The weight reduction module 740 is configured to control the operation of the modules 742-752 to perform the various operations for reducing a precision of weights and inputs in a multiply-and-accumulate (MAC) operation consistent with an illustrative embodiment. The attributes module 742 provides information about the various operations used to generate respective set-points of the various processes site-wide, and such information is used by the machine learning module 748 to model the complex processes of the network. For example, the machine learning module 748 uses information from the attributes module to update the network in terms of matrix size, weights, etc. The network tuning and training module 752 is configured to create and tune various models depending on the application. One non-limiting example would be creating and tuning mixed regression models and mixed control models.

### Example Cloud Platform

As discussed above, functions relating to the low bandwidth transmission of high definition video data may include a cloud. It is to be understood that although this disclosure includes a detailed description of cloud computing as discussed herein below, implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

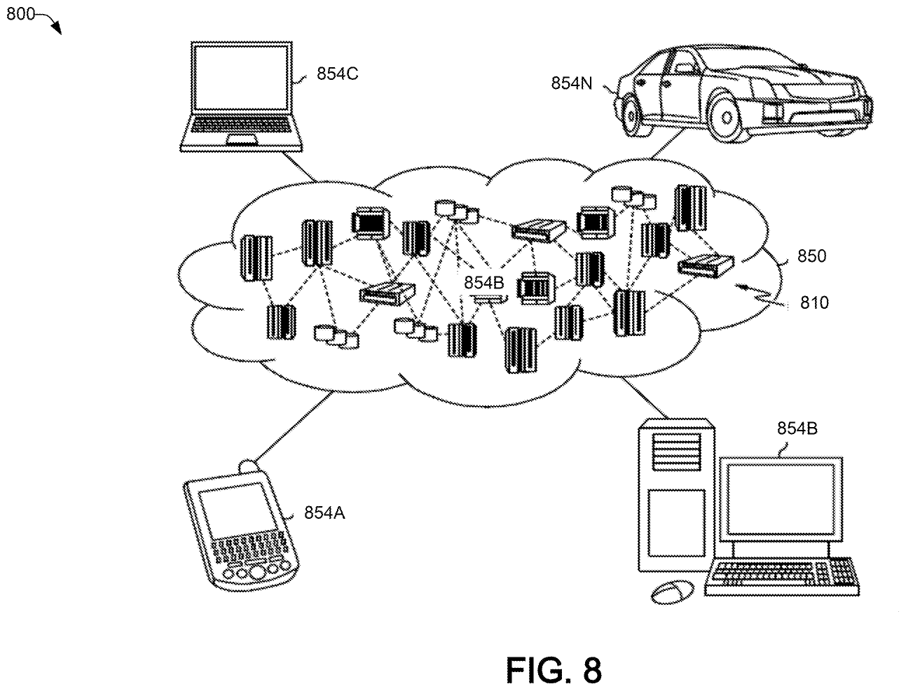

Referring now to FIG. 8, an illustrative cloud computing environment 800 utilizing cloud computing is depicted. As shown, cloud computing environment 800 includes cloud 850 having one or more cloud computing nodes 810 with which local computing devices used by cloud consumers, such as, for example, personal digital assistant (PDA) or cellular telephone 854A, desktop computer 854B, laptop computer 854C, and/or automobile computer system 854N may communicate. Nodes 810 may communicate with one another. They may be grouped (not shown) physically or virtually, in one or more networks, such as Private, Community, Public, or Hybrid clouds as described hereinabove, or a combination thereof. This allows cloud computing environment 800 to offer infrastructure, platforms, and/or software as services for which a cloud consumer does not need to maintain resources on a local computing device. It is understood that the types of computing devices 854A-N shown in FIG. 8 are intended to be illustrative only and that computing nodes 810 and cloud computing environment 800 can communicate with any type of computerized device over any type of network and/or network addressable connection (e.g., using a web browser).

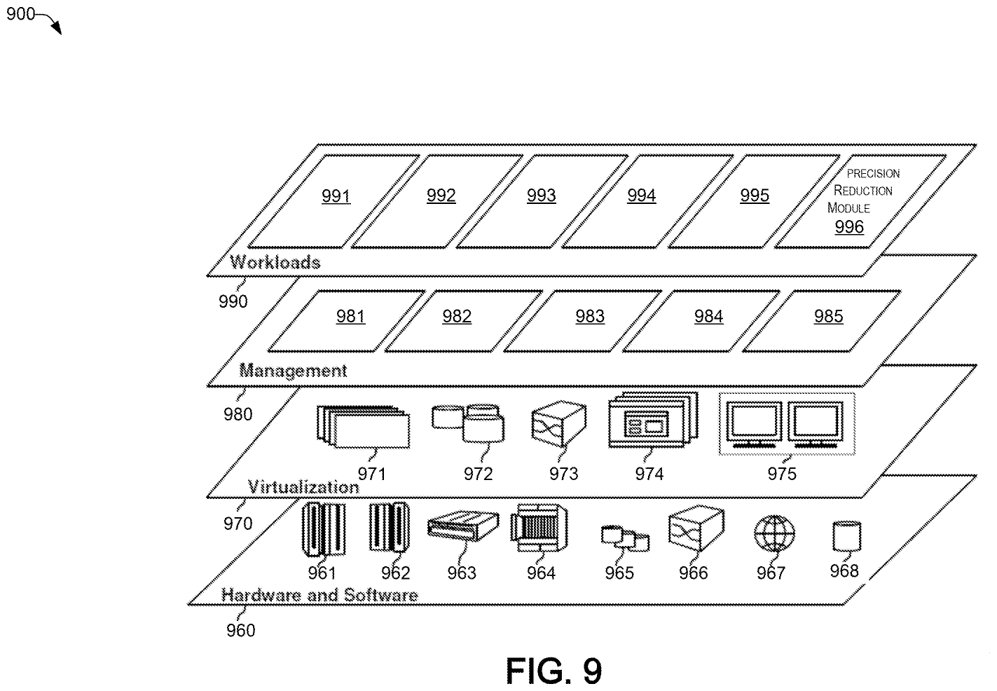

Referring now to FIG. 9, a set of functional abstraction layers 900 provided by cloud computing environment 900 (FIG. 9) is shown. It should be understood in advance that the components, layers, and functions shown in FIG. 9 are intended to be illustrative only and embodiments of the disclosure are not limited thereto. As depicted, the following layers and corresponding functions are provided:

Hardware and software layer 960 include hardware and software components. Examples of hardware components include: mainframes 961; RISC (Reduced Instruction Set Computer) architecture-based servers 962; servers 963; blade servers 964; storage devices 965; and networks and networking components 966. In some embodiments, software components include network application server software 967 and database software 968.

Virtualization layer 970 provides an abstraction layer from which the following examples of virtual entities may be provided: virtual servers 971; virtual storage 972; virtual networks 973, including virtual private networks; virtual applications and operating systems 974; and virtual clients 975.

In one example, management layer 980 may provide the functions described below. Resource provisioning 981 provides dynamic procurement of computing resources and other resources that are utilized to perform tasks within the cloud computing environment. Metering and Pricing 982 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 983 provides access to the cloud computing environment for consumers and system administrators. Service level management 984 provides cloud computing resource allocation and management such that required service levels are met. Service Level Agreement (SLA) planning and fulfillment 985 provide pre-arrangement for, and procurement of, cloud computing resources for which a future requirement is anticipated in accordance with an SLA.

Workloads layer 990 provides examples of functionality for which the cloud computing environment may be utilized. Examples of workloads and functions which may be provided from this layer include: mapping and navigation 991; software development and lifecycle management 992; virtual classroom education delivery 993; data analytics processing 994; transaction processing 995; and a reduction module 996 configured to reduce a precision of weights and inputs in a multiply-and-accumulate (MAC) operation, as discussed herein above.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently. For example, the extraction of the random matrix is not limited to Gaussian, uniform, triangular and Cauchy distributions.

The flowchart, and diagrams in the figures herein illustrate the architecture, functionality, and operation of possible implementations according to various embodiments of the present disclosure.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method to increase resilience to a reduced precision of weights and inputs in a multiply-and-accumulate (MAC) operation, the method comprising:
providing a matrix M and its pseudoinverse M⁻¹;
multiplying a weight matrix W with M⁻¹ and an input vector value x with M;
defining two new matrices W₂ and x₂ based on the multiplying of W with M⁻¹ and x with M; and
encoding the matrices W₂ and x₂ with increased resilience to reduced precision in place of the weights W and input vector value x.

2. The computer implemented method according to claim 1, further comprising providing the pseudoinverse M⁻¹ by performing a Moore Penrose inversion pinv.

3. The computer implemented method according to claim 1, wherein a quantity of weights in W₂ is greater than in W.

4. The computer implemented method according to claim 1, further comprising reducing the precision of each weight in W₂ by performing a quantizing operation to decrease a number of bits per weight

5. The computer implemented method according to claim 1, further comprising reducing the precision of each weight in W₂ by encoding W₂ in Analog hardware.

6. The computer implemented method according to claim 1, wherein the provided matrix M comprises a random matrix.

7. The computer implemented method according to claim 1, further comprising quantizing W₂ and M.

8. The computer implemented method according to claim 7, wherein the provided random matrix M is extracted from a Gaussian distribution.

9. The computer implemented method according to claim 7, wherein the provided random matrix is extracted from a distribution selected from the group consisting of uniform, Cauchy and triangular.

10. The computer implemented method according to claim 1, further comprising reducing the precision of each weight in W₂ by encoding W₂ and M in Analog hardware.

11. A computing device configured to be resilient to a reduced precision of weights and inputs in a multiply-and-accumulate (MAC) operation, the computing device comprising:
a processor;
a memory coupled to the processor, the memory storing instructions to cause the processor to perform acts comprising:
providing a matrix M and its pseudoinverse M⁻¹;
multiplying weights W with M⁻¹ and an input vector value x with M;
defining two new matrices W₂ and x₂ based on the multiplying of W with M⁻¹ and x with M; and
encoding the matrices W₂ and x₂ with increased resilience to reduce precision in place of the weights W and input vector value x.

12. The computing device according to claim 11, wherein the instructions cause the processor to perform an additional act comprising providing the pseudoinverse M⁻¹ by performing a Moore Penrose inversion pinv.

13. The computing device according to claim 11, wherein a quantity of weights in W₂ is greater than in W.

14. The computing device according to claim 11, wherein the instructions cause the processor to perform an additional act comprising reducing a precision of each weight in W₂ by performing a quantizing operation.

15. The computing device according to claim 11, wherein the instructions cause the processor to perform an additional act comprising reducing the precision of each weight in W₂ by encoding W₂ in Analog hardware.

16. The computing device according to claim 11, wherein the instructions cause the processor to perform an additional act comprising providing a random matrix.

17. The computing device according to claim 16, wherein the instructions cause the processor to perform an additional act comprising extracting the random matrix from a distribution selected from the group consisting of Gaussian, uniform, Cauchy and triangular.

18. The computing device according to claim 11, wherein the instructions cause the processor to perform an additional act comprising quantizing W₂ and M.

19. The computing device according to claim 11, wherein the instructions cause the processor to perform an additional act comprising reducing the precision of each weight in W₂ and M by encoding W₂ and M in Analog hardware.

20. A non-transitory computer readable storage medium tangibly embodying a computer readable program code having computer readable instructions that, when executed, causes a computer device to carry out a method to reduce a precision of weights and inputs in a multiply-and-accumulate (MAC) operation, the method comprising:
providing a matrix M and its pseudoinverse M⁻¹;
multiplying weights W with M⁻¹ and an input vector value x with M; and
defining two new matrices W₂ and x₂ based on the multiplying of W with M⁻¹ and x with M.
